(19) United States
(12) Patent Application Publication
(10) Pub. No.: US 2001/0006005 A1
(43) Pub. Date: Jul. 5, 2001

(54) Flow rate measuring apparatus with a flow rate detector protecting structure

(75) Inventors: Kunihiko Sato, Gunma (JP); Koichi Fujiwara, Gunma (JP); Jun Arai, Gunma (JP)

Correspondence Address: Foley & Lardner, 3000 K Street, N.W., P.O. Box 25696, Washington, DC, 20007-8696, US

(73) Assignee: UNISIA JECS CORPORATION

(21) Appl. No.: 09/742,427

(22) Filed: Dec. 22, 2000

(30) Foreign Application Priority Data
Dec. 28, 1999 (JP) 11-373639

(51) Int. Cl. G01F 1/68

(52) U.S. Cl. 73/204.22

(57) ABSTRACT

A flow rate measuring apparatus including a housing formed with a passage receiving a part of the gas flowing in an intake air passage. A flow rate detection element is disposed within the passage, which detects a flow rate of the part of the gas. At least one impingement wall is disposed within the passage upstream of the flow rate detection element, against which the part of the gas impinges. The passage is bent at the impingement wall to divert the part of the gas for preventing the part of the gas from directly hitting against the flow rate detection element.

### BACKGROUND OF THE INVENTION

The present invention relates to an apparatus for measuring a flow rate of gas, which is useable for measuring a flow rate of intake air introduced into a vehicular engine.

Generally, a vehicular engine of a fuel injection type is provided with an apparatus for measuring a flow rate of intake air introduced for forming an air-fuel mixture at an appropriate air-fuel ratio within the engine. An amount of fuel injection is determined based on outputs indicative of the flow rate measured by the apparatus. Japanese Patent Provisional Publication No. 9-4487 discloses gas flow rate measuring apparatuses each of which includes a housing disposed within an intake pipe, a bypass passage formed in the housing and a flow rate detection element disposed within the bypass passage. The bypass passage allows a part of intake air passing through an intake air passage within the intake pipe to flow therein. The bypass passage has inlet and outlet ports open to an outer surface of the housing. The bypass passage includes a linearly extending inlet portion connected with the inlet port, within which the flow rate detection element is disposed. The inlet port is directed toward the upstream of the intake air flow and the inlet portion is linearly located along the intake air flow. The part of the intake air flowing into the inlet portion of the bypass passage through the inlet port passes over the flow rate detection element and then flows through the outlet port into the intake air passage again. Meanwhile, there is known a thermosensitive resistor as the flow rate detection element, which is formed, for instance, by etching a metal film, such as platinum film, disposed on a substrate. The thermosensitive resistor is adapted to be heated upon being electrically energized by the activating operation. In the activated state, the thermosensitive resistor is cooled by the contact with the intake air flowing in the bypass passage and detects the flow rate of the intake air by sensing the change in temperature thereof, i.e., the change in resistance value thereof.

However, in a case where an air cleaner element having a low dust-trap capacity is used in an intake air system of the vehicle, an intake air containing foreign objects may be introduced into the bypass passage through the inlet portion at a relatively high speed upon the engine accelerating operation. The foreign objects will then impinge against the flow rate detection element in the inlet portion of the bypass passage. If the impingement of the foreign objects repeatedly occurs during a long period of time, the flow rate detection element will suffer from troubles such as malfunctions, damages and the like. This may lead to deterioration in durability and life of the flow rate detection element. Further, since the thermosensitive resistor as the flow rate detection element includes a fine metal film, the thermosensitive resistor tends to be damaged in a short period even by a slight impingement of the foreign objects thereagainst in the case of using the air cleaner element having a low dust-trap capacity.

### SUMMARY OF THE INVENTION

It is an object of the present invention to provide a flow rate measuring apparatus capable of preventing the foreign objects contained in a gas to be measured from being directly impinged against a flow rate detection element at high speed, and then improving durability and life of the flow rate detection element.

According to one aspect of the present invention, there is provided a flow rate measuring apparatus useable within a gas passage in which gas flows, the apparatus comprising:

a housing;

a passage formed through the housing, said passage allowing a part of the gas to flow from the gas passage thereinto;

a flow rate detection element detecting a flow rate of the part of the gas, said flow rate detection element disposed within the passage; and

at least one impingement wall against which the part of the gas impinges, said impingement wall being disposed within the passage upstream of the flow rate detection element, said passage being bent at the impingement wall to divert the part of the gas.

According to a further aspect of the present invention, there is provided an apparatus for measuring a flow rate of gas, the apparatus comprising:

a wall;

a passage defined by the wall, said passage comprising an inlet portion and at least one bent portion bent relative to the inlet portion;

a flow rate detection element detecting the flow rate of the gas flowing through the passage, said flow rate detection element being disposed within the passage downstream of the bent portion; and

an impingement wall against which a flow of the gas entering into the bent portion of the passage hits before the flow of the gas reaches the flow rate detection element.

The other objects and features of this invention will become understood from the following description with reference to the accompanying drawings.

### BRIEF DESCRIPTION OF THE DRAWINGS

FIG. 1 is a front view of a flow rate measuring apparatus of a first embodiment, according to the present invention, which is mounted to a pipe;

FIG. 2 is a cross section, taken along the line 2-2 of FIG. 1;

FIG. 3 is an enlarged view of an important part of FIG. 2, showing a bypass passage of the apparatus and a flow rate detection element;

FIG. 4 is an enlarged perspective view of the flow rate detection element;

FIG. 5 is a view similar to FIG. 3, but showing the apparatus of a second embodiment, according to the present invention; and

FIG. 6 is a view similar to FIG. 3, but showing a modification of the apparatus of the first embodiment.

### DETAILED DESCRIPTION OF THE INVENTION

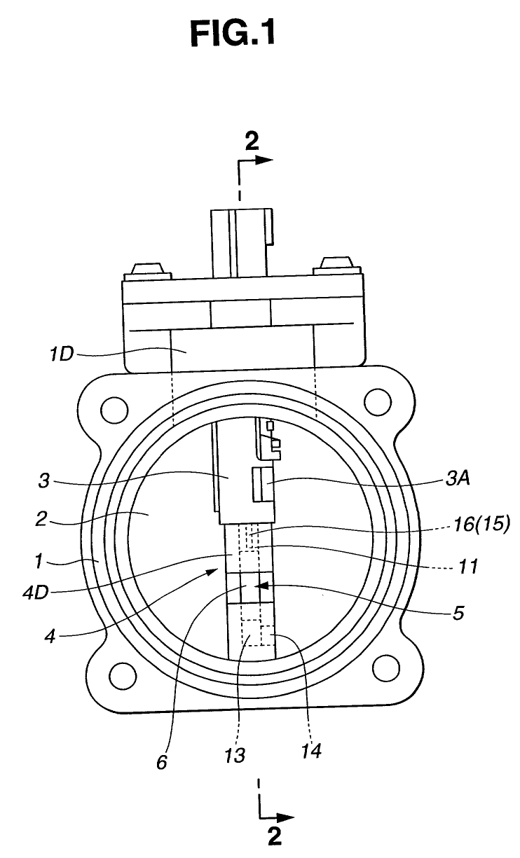

Referring now to FIGS. 1-4, a flow rate measuring apparatus, according to the present invention, of a first embodiment is explained, which is an intake-air flow rate measuring apparatus applicable to a vehicular engine.

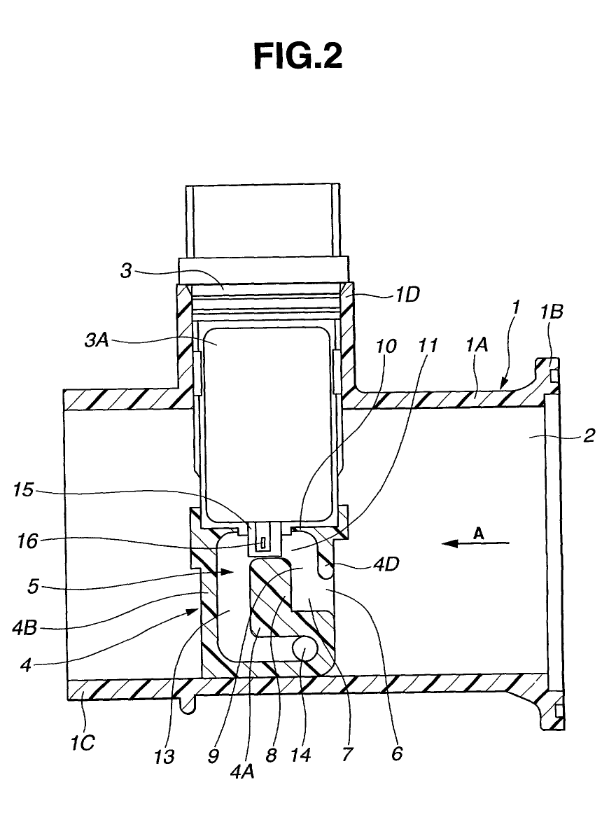

As illustrated in FIG. 1, the apparatus is mounted to a pipe 1. The pipe 1 is disposed in an intake pipe of the engine, not shown, formed into a generally cylindrical shape, and made of resin, metal or the like. As illustrated in FIG. 2, the pipe 1 includes a generally cylindrical wall 1A defining an intake air passage 2 as a main passage, a connecting flange 1B connected with an upstream end of the wall 1A, and a cylindrical connecting portion 1C connected with a downstream end of the wall 1A. The pipe 1 is connected with an air cleaner at the connecting flange 1B and with cylinders of the engine at the connecting portion 1C. An intake air passing through the air cleaner enters the intake air passage 2 and flows therein in a direction indicated by the arrow A toward the engine cylinders.

A sensor support 3 is mounted to the pipe 1. The sensor support 3 includes a connecting portion fitted to a sensor mounting portion 1D of the pipe 1, and an element support portion connected with the connecting portion and projecting into the intake air passage 2. The element support portion supports at a distal end thereof a flow rate detection element 16 mounted to an element mounting portion 15. The element support portion includes a circuit receiving portion 3A receiving an electronic circuit, not shown, in electronic communication with the flow rate detection element 16. The distal end of the element support portion is connected with a housing 4 as a passage formation member in which a bypass passage 5 receiving and diverting a part of the intake air within the intake air passage 2 is formed.

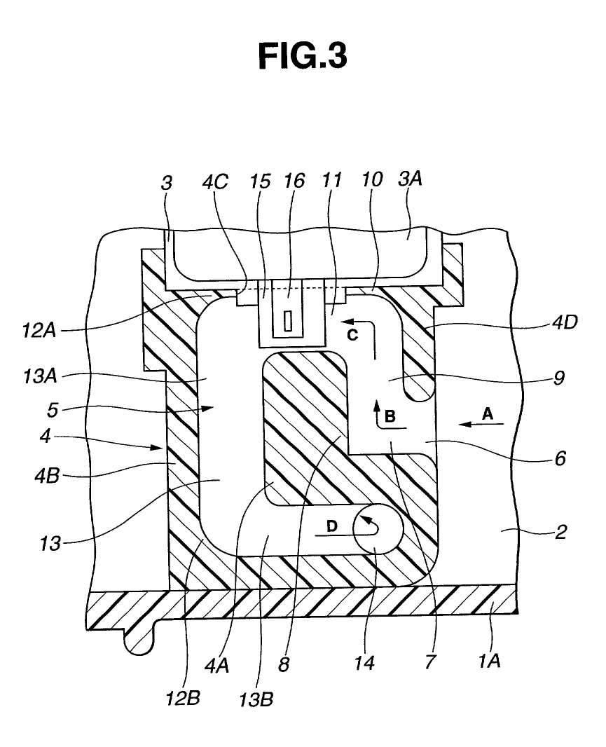

The housing 4 has a generally cubic shape as seen from FIGS. 1-3, which is made of a resin material. The housing 4 is fixed to an inner surface of the wall 1A of the pipe 1. The housing 4 includes a wall defining the bypass passage 5. As best shown in FIG. 3, the wall of the housing 4 includes an inner wall portion 4A and an outer surrounding wall portion 4B between which the bypass passage 5 is formed. The wall of the housing 4 is formed with an element insertion hole 4C extending through an upper wall portion of the outer surrounding wall portion 4B to be open into the bypass passage 5. The flow rate detection element 16 projects through the insertion hole 4C into the bypass passage 5 to be exposed to the intake air within the bypass passage 5. A barrier 4D is so arranged as to prevent the intake air within the intake air passage 2 from directly hitting on the flow rate detection element 16 after straightly flowing into the bypass passage 5 in the direction A shown in FIG. 3. The barrier 4D is disposed in the vicinity of an inlet port 6 of the bypass passage 5. The barrier 4D is located on the front side of the outer surrounding wall portion 4B and depends from the upper wall portion of the outer surrounding wall portion 4B toward the inlet port 6.

The bypass passage 5 has a generally C-shaped section as shown in FIG. 3 and includes a plurality of bent portions forming corner portions of the generally C-shaped section. Namely, the bypass passage 5 includes an inlet portion 7 extending straightly from the inlet port 6, an outlet portion 13 with an outlet port 14, and an intermediate portion between the inlet portion 7 and the outlet portion 13. The intermediate portion includes an upstream connecting portion 9 connected with the inlet portion 7 and bent relative thereto, and a downstream connecting portion 11 connected with the upstream connecting portion 9 and bent relative thereto. The bypass passage 5 allows the part of the intake air within the intake air passage 2 to flow into the inlet portion 7, pass through the upstream and downstream connecting portions 9 and 11, and be discharged from the outlet port 14 through the outlet portion 13. The part of the intake air flowing through the bypass passage 5 thus be returned into the intake air passage 2. The flow rate detection element 16 of the sensor support 3 projects into the downstream connecting portion 11 of the intermediate portion.

First and second impingement walls 8 and 10 are disposed within the upstream and downstream connecting portions 9 and 11 of the bypass passage 5 upstream of the flow rate detection element 16. The part of the intake air passing through the inlet portion 7 hits against the impingement wall 8 and then the impingement wall 10 to be diverted. The impingement wall 8 allows the flow of the part of the intake air flowing through the inlet portion 7 to be changed along a direction B shown in FIG. 3, substantially perpendicular to the direction A, and directed into the upstream connecting portion 9. The impingement wall 10 allows the flow of the part of the intake air flowing through the upstream connecting portion 9 to be changed along a direction C shown in FIG. 3, substantially perpendicular to the direction B, and directed into the downstream connecting portion 11. The impingement walls 8 and 10 prevent the part of the intake air entering the bypass passage 5 from directly hitting on the flow rate detection element 16 and cooperate to prevent any foreign objects present in the part of the intake air from impinging against the flow rate detection element 16, as explained later.

Specifically, the outer surrounding wall portion 4B of the housing 4 has an upstream-side wall portion facing the air cleaner and a downstream-side wall portion facing the engine cylinders, relative to the intake air flow in the direction A shown in FIG. 3. The inlet port 6 is open to an outer surface of the upstream-side wall portion of the outer surrounding wall portion 4B and directed to the intake air flow flowing in the direction A. The inlet portion 7 extends straightly from the inlet port 6 and substantially along the direction A of the flow of the intake air. The inlet portion 7 encounters at a downstream end thereof with the impingement wall 8. The impingement wall 8 is located on an upstream-side of the inner wall portion 4A relative to the intake air flow in the direction A. The inlet portion 7 is connected with the upstream connecting portion 9 that is bent at the impingement wall 8 and extends substantially perpendicular to the inlet portion 7. The impingement wall 8 is disposed between the inlet portion 7 and the upstream connecting portion 9. The upstream connecting portion 9 encounters at a downstream end thereof with the impingement wall 10. The impingement wall 10 is located on the upstream side of the upper wall portion of the outer surrounding wall portion 4B. The upstream connecting portion 9 is connected with the downstream connecting portion 11 into which the flow rate detection element 16 projects. The downstream connecting portion 11 extends substantially perpendicular to the upstream connecting portion 9. The downstream connecting portion 11 encounters at a downstream end thereof with an upper part of the downstream-side wall portion of the outer surrounding wall portion 4B of the housing 4. The downstream connecting portion 11 is connected with the outlet portion 13. The outlet portion 13 having a generally L-shape includes an upstream outlet portion 13A extending substantially perpendicular to the downstream connecting portion 11, and a downstream outlet portion 13B connected with the upstream outlet portion 13A and extending substantially perpendicular thereto. The upstream outlet portion 13A terminates at a bottom wall portion of the outer surrounding wall portion 4B of the housing 4. The downstream outlet portion 13B is connected with the outlet port 14 located substantially perpendicular thereto. The outlet port 14 is open to an outer surface of a right side wall portion of the outer surrounding wall portion 4B of the housing 4 as viewed in FIG. 1.

Disposed downstream of the flow rate detection element 16 are three counter flow impingement walls preventing a counter flow of the intake air which entering from the intake air passage 2 into the outlet portion 13 through the outlet port 14 from directly hitting against the flow rate detection element 16. The counter flow of the intake air hits against the counter flow impingement walls to be diverted. A first counter flow impingement wall is disposed between the outlet port 14 and the downstream outlet portion 13B of the outlet portion 13 so as to be hit by the counter flow passing through the outlet port 14. The first counter flow impingement wall is located on the left side wall portion, as viewed in FIG. 1, of the outer surrounding wall portion 4B of the housing 4, which is opposed to the outlet port 14. A second counter flow impingement wall 12B is disposed between the upstream outlet portion 13A and the downstream outlet portion 13B so as to be hit by the counter flow passing through the downstream outlet portion 13B. The second counter flow impingement wall 12B is located at a lower part of the downstream-side wall portion of the outer surrounding wall portion 4B. A third counter flow impingement wall 12A is disposed between the upstream outlet portion 13A and the downstream connecting portion 11 so as to be hit by the counter flow passing through the upstream outlet portion 13A. The third counter flow impingement wall 12A is located on the downstream side of the upper wall portion of the outer surrounding wall portion 4B.

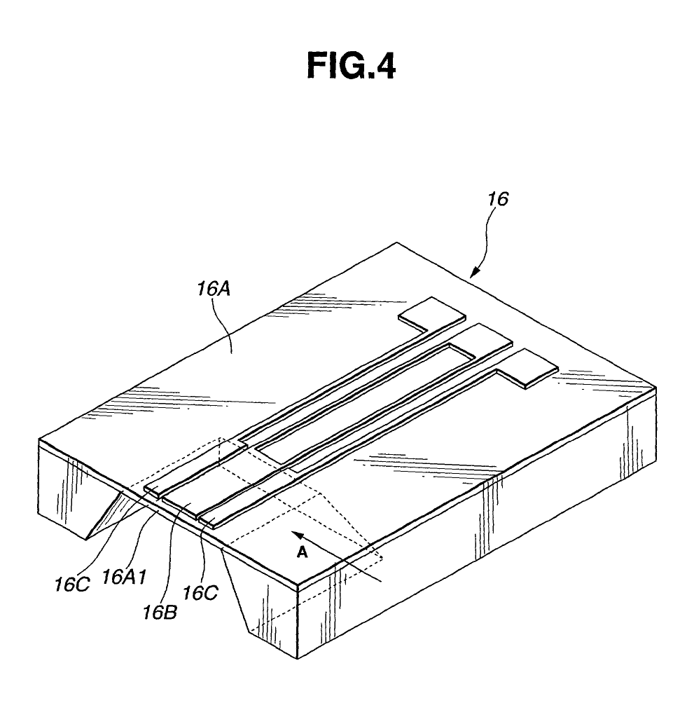

The flow rate detection element 16 located within the downstream connecting portion 11 is fixed to the element mounting portion 15. The element mounting portion 15 is secured at a base portion thereof to the circuit receiving portion 3A of the sensor support 3 in such a manner that a retainer portion thereof retaining the flow rate detection element 16 projects into the downstream connecting portion 11 through the element insertion hole 4C. As illustrated in FIG. 4, the flow rate detection element 16 includes a base plate 16A, a diaphragm 16A1 disposed on the base plate 16A, a heater 16B disposed on the diaphragm 16A1 and thermosensitive resistors 16C, 16C disposed on the left and right sides of the heater 16B, respectively. The thermosensitive resistors 16C, 16C cooperate with the electronic circuit within the circuit receiving portion 3A to form a bridge circuit, not shown. The base plate 16A is made of silicon material, ceramic material or the like. The heater 16B and the thermosensitive resistors 16C, 16C are formed by etching films made of metal such as platinum. Upon activation of the flow rate detection element 16, the heater 16B is energized by the electronic circuit and heated to transmit the heat to the thermosensitive resistors 16C, 16C. The thermosensitive resistors 16C, 16C are cooled by the contact with the intake air flowing into the downstream connecting portion 11, while receiving the heat from the thermosensitive resistors 16C, 16C. The flow rate detection element 16 detects the flow rate of the intake air by sensing the change in the resistance value of the thermosensitive resistors 16C, 16C that is caused depending on the change in the temperature thereof.

An operation of the apparatus of the first embodiment will be explained hereinafter.

An intake air flows in the intake air passage 2 of the intake pipe 1 in the direction A as shown in FIG. 3 during the engine operation. When the intake air within the intake air passage 2 enters into the inlet port 6 of the bypass passage 5, the intake air hits on the barrier 4D disposed near the inlet port 6 to be prevented from straightly flowing in the direction A. A part of the intake air enters into the inlet portion 7 through the inlet port 6. The part of the intake air flow hits against the impingement wall 8 to be diverted along the direction B substantially perpendicular to the direction A, flowing into the upstream connecting portion 9. The intake air flow passing through the upstream connecting portion 9 hits against the impingement wall 10 to be diverted along the direction C. The intake air flow then enters into the downstream connecting portion 11 and passes over the flow rate detection element 16. Thus, the direction of the intake air flow flowing into the bypass passage 5 is changed upstream of the flow rate detection element 16 twice, at each time the direction being changed at substantially the right angle, with the hit of the intake air flow against the impingement walls 8 and 10. In a case where the intake air containing any foreign objects such as dusts flows into the bypass passage 5, the foreign objects present in the intake air flow will also enter into the inlet port 6 at high speed. The foreign objects present in the intake air flow passing through the inlet port 6 flows into the inlet portion 7 and then the upstream and downstream connecting portions 9 and 11. At this time, the foreign objects present in the intake air flow hit against the impingement walls 8 and 10 due to a large inertial mass thereof. Thus, the speed of the foreign objects can be reduced on the upstream side of the flow rate detection element 16 so that the foreign objects can pass over the flow rate detection element 16 within the downstream connecting portion 11 at the reduced speed. The flow rate detection element 16 can be thus prevented from being hit by the foreign objects present in the intake air at high speed. Even if the foreign objects hit on the flow rate detection element 16, the impingement energy caused by the hit can be decreased because of the reduced speed of the foreign objects. Accordingly, the flow rate detection element 16 using the fine metal film can be protected from being adversely influenced by the foreign objects present in the intake air, so that the durability and life of the flow rate detection element 16 can be improved. The flow rate detection element 16 detects a flow rate of the intake air passing thereover in the downstream connecting portion 11 and generates a signal output indicative of the detected flow rate of the intake air. The intake air then flows into the outlet portion 13, passes through the upstream and downstream outlet portions 13A and 13B, and returns to the intake air passage 2 through the outlet port 14 as indicated by the arrow D shown in FIG. 3.

If a counter flow of the intake air flowing in a direction reverse to the direction A occurs in the intake air passage 2, the counter flow of the intake air can be prevented from entering into the outlet port 14 because of the outlet port 14 open in the direction substantially perpendicular to the direction of the counter flow. Even in a case where the counter flow of the intake air enters into the outlet port 14, the counter flow can in turn hit against the counter flow impingement wall at the downstream end portion of the downstream outlet portion 13B which is connected with the outlet port 14, the counter flow impingement wall 12B at the downstream end portion of the upstream outlet portion 13A, and the counter flow impingement wall 12A at the downstream end portion of the downstream connecting portion 11. Therefore, the counter flow can be attenuated before reaching the flow rate detection element 16 and can be prevented from directly hitting on the flow rate detection element 16. The flow rate detection element 16 can be protected from adverse influence to be caused by the direct hit of the counter flow. Alternatively, the flow rate detection element 16 may be arranged within the upstream connecting portion 9 or the outlet portion 13. The outlet port 14 may also be open to an outer surface of the downstream-side wall portion of the outer surrounding wall portion 4B.

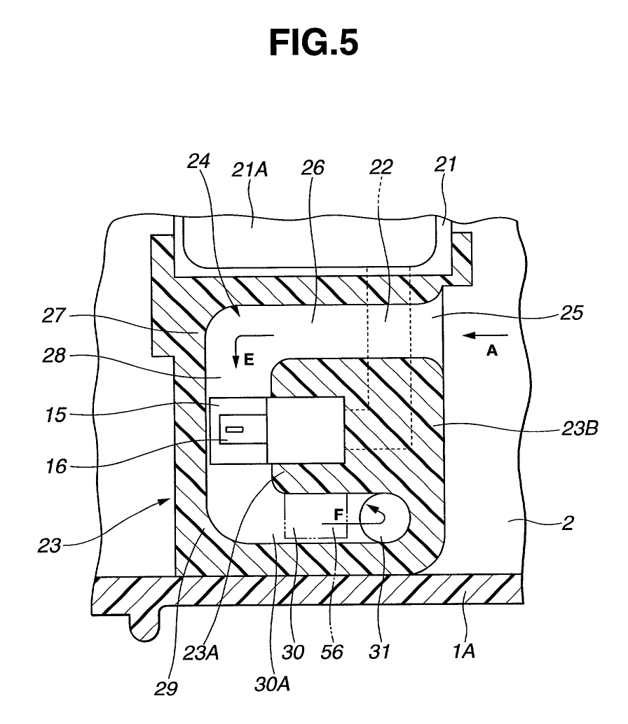

Referring now to FIG. 5, the apparatus of the second embodiment, according to the invention, is explained, which differs in that the bypass passage is bent once on the upstream side of the flow rate detection element. Like reference numerals denote like parts, and therefore, detailed explanations therefor can be omitted.

As illustrated in FIG. 5, a sensor support 21 includes a circuit receiving portion 21A, similar to the first embodiment. An electronic circuit within the circuit receiving portion 21A is connected with the flow rate detection element 16 through a wiring member 22. The wiring member 22 is arranged outside a housing 23 as a passage formation member that is formed with a bypass passage 24. The housing 23 is disposed within the intake air passage 2 and specifically, secured to the inner surface of the wall 1A of the pipe 1 at the distal end of the sensor support 21 which projects into the intake air passage 2. Similar to the housing 4 of the first embodiment, the housing 23 has a generally cubic shape and includes an inner wall portion 23A and an outer surrounding wall portion 23B between which the bypass passage 24 is formed. The flow rate detection element 16 is secured to the inner wall portion 23A so as to project into the bypass passage 24.

The bypass passage 24 has a generally C-shaped section as shown in FIG. 5 and includes an inlet portion 26 with an inlet port 25, an outlet portion 30 with an outlet port 31, and an intermediate portion 28 therebetween. The inlet port 25 is open to an outer surface of an upstream-side wall portion relative to the intake air flow flowing in the direction A, of the outer surrounding wall portion 23B. The inlet portion 26 straightly extends from the inlet port 25 along the direction A and encounters at a downstream end thereof with an impingement wall 27. The inlet portion 26 is connected with the intermediate portion 28 bent relative to the inlet portion 26. The intermediate portion 28 extends substantially perpendicular to the inlet portion 26. The flow rate detection element 16 is located within the intermediate portion 28. The impingement wall 27 is located on an upper part of a downstream-side wall portion relative to the intake air flow, of the outer surrounding wall portion 23B. The intermediate portion 28 encounters at a downstream end thereof with the downstream side of a bottom wall portion of the outer surrounding wall portion 23B. The intermediate portion 28 is communicated with the outlet portion 30. The outlet portion 30 is bent at substantially the right angle relative to the intermediate portion 28. The outlet portion 30 is connected with the outlet port 31 that extends substantially perpendicular thereto through the side wall portion of the outer surrounding wall portion 23B to be open to an outer surface of the side wall portion, similar to the outlet port 14 of the first embodiment. Further, two counter flow impingement walls are provided within the bypass passage 24 downstream of the flow rate detection element 16. The one of the counter flow impingement walls is, as indicated at 29, located at the lower part of the downstream-side wall portion of the outer surrounding wall portion 23B. The other of the counter flow impingement walls is located on the upstream side of the side wall portion of the outer surrounding wall portion 23B which is opposed to the outlet port 31.

When a part of the intake air flowing through the intake air passage 2 in the direction A enters into the inlet portion 26 through the inlet port 25, the part of the intake air hits on the impingement wall 27. Then, the direction of the flow of the part of the intake air is changed as indicated by the arrow E so that the part of the intake air enters into the intermediate portion 28 and passes over the flow rate detection element 16 within the intermediate portion 28. The intake air flow passing through the intermediate portion 28 enters into the outlet portion 30 and the outlet port 31 and then returns into the intake air passage 2 as indicated by the arrow F. If a counter flow of the intake air entering into the outlet port 31 from the intake air passage 2 occurs, the counter flow will hit against the two counter flow impingement walls to be attenuated.

The apparatus of the second embodiment can exhibit substantially the same effects as those of the first embodiment. That is, with the arrangement of the impingement wall 27 and the intermediate portion 28 bent thereat, the intake air flow flowing from the inlet portion 26 into the intermediate portion 28 can be prevented from directly hitting against the flow rate detection element 16. Therefore, any foreign objects present in the intake air flow can hit against the impingement wall 27 before reaching the flow rate detection element 16. The impingement energy of the foreign objects can be reduced, whereby the flow rate detection element 16 can be protected from the direct hit of the foreign objects with large impingement energy. Further, even if the counter flow of the intake air enters from the intake air passage 2 into the outlet port 31, the flow rate detection element 16 can be prevented from being adversely affected by the counter flow with the provision of the two counter flow impingement walls.

In addition, since the apparatus of the second embodiment has the simple structure in which the bypass passage 24 is bent only at the intermediate portion 28, the formation of the bypass passage 24 in the housing 23 can be facilitated.

Alternatively, the flow rate detection element may be located in a position as indicated at 56 within the outlet portion 30.

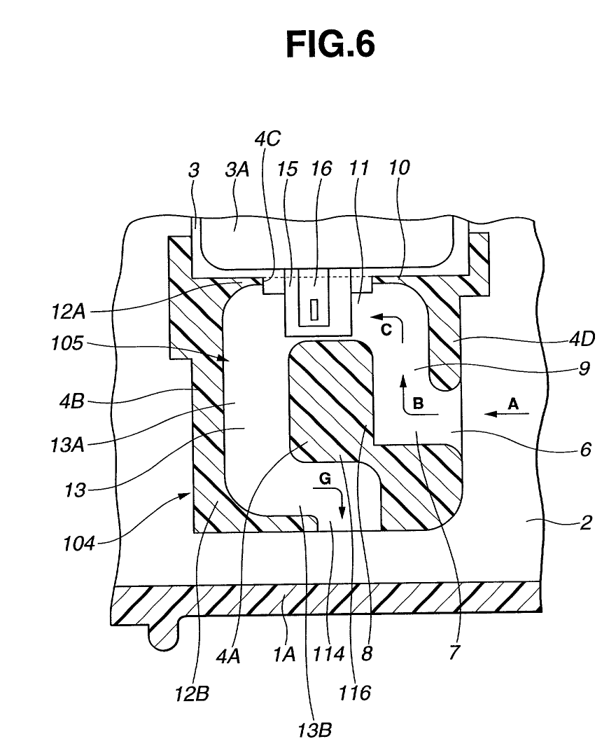

Referring to FIG. 6, there is shown the modification of the apparatus of the first embodiment, which differs in the layout of the housing within the pipe and the arrangement of the outlet port of the bypass passage. Like reference numerals denote like parts, and therefore detailed explanations therefor can be omitted.

As illustrated in FIG. 6, the apparatus includes a housing 104 as the passage formation member having a bypass passage 105. The housing 104 is arranged within the intake air passage 2 with a clearance between the outer surface of the bottom wall portion of the outer surrounding wall portion 4B and the inner surface of the wall 1A of the pipe 1. The bypass passage 105 includes an outlet port 114 extending through the bottom wall portion of the outer surrounding wall portion 4B to be open to an outer surface of the bottom wall portion. A part of the intake air entering into the inlet portion 7 from the intake air passage 2 passes through the upstream and downstream connecting portions 9 and 11 of the intermediate portion and the outlet portion 13 and flows into the outlet port 114 as indicated by the arrow G. The part of the intake air then flows out of the outlet port 114 into the intake air passage 2.

As be appreciated from the above description, the bypass passage can be bent upstream of the flow rate detection element three times or more. Further, the housing as the passage formation member can be arranged in direct contact with the pipe as explained in the first embodiment or without direct contact therewith as explained in the second embodiment. In the case of mounting the housing to the pipe with the direct contact therewith, the housing can be integrally formed with the pipe by using the same resin material.

The entire contents of basic Japanese Patent Application No. 11-373639 filed on Dec. 28, 1999, inclusive of the specification, claims and drawings, are herein incorporated by reference.

Although the invention has been described above by reference to certain embodiments of the invention, the invention is not limited to the embodiments described above. Modifications and variations of the embodiment described above will occur to those skilled in the art, in light of the above teachings. The scope of the invention is defined with reference to the following claims.

What is claimed is:

1. A flow rate measuring apparatus useable within a gas passage in which gas flows, the apparatus comprising:
a housing;
a passage formed through the housing, said passage allowing a part of the gas to flow from the gas passage thereinto;
a flow rate detection element detecting a flow rate of the part of the gas, said flow rate detection element disposed within the passage; and
at least one impingement wall against which the part of the gas impinges, said impingement wall being disposed within the passage upstream of the flow rate detection element, said passage being bent at the impingement wall to divert the part of the gas.

2. A flow rate measuring apparatus as claimed in claim 1, wherein the passage comprises an inlet portion through which the part of the gas enters into the passage, a first connecting portion connected with the inlet portion and bent relative thereto and a second connecting portion connected with the first bent portion and bent relative thereto, said impingement wall comprising a first impingement wall disposed between the inlet portion and the first connecting portion and a second impingement wall disposed between the first connecting portion and the second connecting portion, said flow rate detection element being disposed within the second connecting portion.

3. A flow rate measuring apparatus as claimed in claim 1, wherein the flow rate detection element comprises a thermosensitive resistor comprising a base plate and a metal film disposed on the base plate, said thermosensitive resistor being so constructed as to detect a flow rate of the gas passing over the flow rate detection element by sensing change in value of resistance.

4. A flow rate measuring apparatus as claimed in claim 1, wherein the passage comprises an outlet portion through which the part of the gas is returned to the gas passage, said apparatus further comprising a counter flow impingement wall preventing a counter flow of the gas which enters from the gas passage into the outlet portion from directly hitting against the flow rate detection element, said counter flow impingement wall being disposed within the passage downstream of the flow rate detection element.

5. A flow rate measuring apparatus as claimed in claim 2, wherein the passage comprises an outlet portion through which the part of the gas is returned to the gas passage, said outlet portion being disposed downstream of the second connecting portion, said apparatus further comprising a counter flow impingement wall preventing a counter flow of the gas which enters from the gas passage into the outlet portion from directly hitting against the flow rate detection element, said counter flow impingement wall being disposed within the outlet portion.

6. A flow rate measuring apparatus as claimed in claim 5, wherein the counter flow impingement wall comprises a plurality of the counter flow impingement walls.

7. A flow rate measuring apparatus as claimed in claim 1, further comprising a barrier preventing the gas within the gas passage from directly hitting against the flow rate detection element, said barrier being disposed in the vicinity of the inlet portion.

8. An apparatus for measuring a flow rate of gas, the apparatus comprising:
a wall;
a passage defined by the wall, said passage comprising an inlet portion and at least one bent portion bent relative to the inlet portion;
a flow rate detection element detecting the flow rate of the gas flowing through the passage, said flow rate detection element being disposed within the passage downstream of the bent portion; and
an impingement wall against which a flow of the gas entering into the bent portion of the passage hits before the flow of the gas reaches the flow rate detection element.

9. An apparatus as claimed in claim 8, wherein the passage comprises an outlet portion with an outlet port, said outlet portion being disposed downstream of the bent portion and comprising a bent portion bent relative to the outlet port, said apparatus further comprising a counter flow impingement wall preventing a counter flow of the gas which enters from the outlet port into the bent portion of the outlet portion from directly hitting against the flow rate detection element.

10. An apparatus as claimed in claim 9, wherein the bent portion of the outlet port comprises a plurality of the bent portions, said counter flow impingement wall comprising a plurality of the counter flow impingement walls.

11. An apparatus as claimed in claim 8, wherein the flow rate detection element comprises a thermosensitive resistor comprising a base plate and a metal film disposed on the base plate, said thermosensitive resistor being so constructed as to detect a flow rate of the gas passing over the flow rate detection element by sensing change in value of resistance.

12. An apparatus as claimed in claim 8, further comprising a barrier preventing the gas from directly hitting against the flow rate detection element, said barrier being disposed in the vicinity of the inlet portion.
